(19) United States
(12) Patent Application Publication
(10) Pub. No.: US 2018/0320815 A1
(43) Pub. Date: Nov. 8, 2018

(54) COLLAPSIBLE SUPPORT BASE FOR VERTICAL POSTS

(71) Applicant: Jumping Targets, LLC, Lehi, UT (US)

(72) Inventor: Jared Miller, Lehi, UT (US)

(73) Assignee: Jumping Targets, LLC, Lehi, UT (US)

(21) Appl. No.: 15/586,445

(22) Filed: May 4, 2017

(51) Int. Cl. F16M 11/38

(52) U.S. Cl. CPC F16M 11/38; F16M 2200/08

(57) ABSTRACT

This disclosure relates generally to a support base, which includes a support leg that is rigidly joined to a first connector and a second connector. The first connector includes a post aperture while the second connector also includes a second post aperture. The first connector and the second connector further include a plurality of pinning apertures. The support base also includes a pivotable support leg, which includes a pin that is disposed within one of the plurality of pinning apertures in the first connector and within one of the plurality of pinning apertures in the second connector. In this manner, the support base may be collapsible by pivoting or rotating the pivotable support leg towards the support leg.

### BACKGROUND

### 1. Technical Field

This disclosure relates generally to a device that acts as a base for vertical or upright posts and other objects that are intended to be secured in a vertical position. More specifically, the device operates collapsible base for vertical signage, posts, Christmas trees, and a host of other objects that is both durable and resistant to forcible impacts.

### 2. Description of the Related Art

Bases are conventional devices used to support upright or vertical objects. Conventional bases include weight-based bases, closed bases, open bases, tripods/bipods/monopods, and others. Weight-based bases, for example, may be seen in a variety of applications, including lamps, play equipment, such as a tetherball stand, among other applications. The principle of operation for such bases is that instead of driving a post into the ground or physically attaching an object to another object, a base is created in the object providing a substantial amount of weight, relative to the object's total weight sufficient to prevent the object from falling over when situated in an upright position. In one example, a torch-style floor lamp includes a wide weighted base, often filled with sand or water for weight, and a slender upright column portion supporting a light socket within a lamp shade. The width and the weight of the base maintains the column portion, the light socket, and the lamp shade within an upright position. In another example, a tetherball pole may be cemented inside a used tire. The weight of the cement in the width of the tire supports the upright pole such that when a tetherball is attached, the tetherball may be forcefully struck without tipping or knocking over the tetherball pole.

Closed bases are those that allow a post to be inserted into the base, but can extend into the closed base no farther than a bottom installed in the base. For example, typical Christmas tree bases are configured to receive a base of a Christmas tree until the tree rests on the bottom of the base. Clamps are typically installed within the base that push against a trunk of the tree and maintain it in a vertical position. A closed base is particularly appropriate for such an application because it allows a user to place water in the base, which is then absorbed by the tree.

Open bases differ from closed bases. Open bases typically do not include a bottom allowing an object to slide completely through the open base and rest on the ground. An object may then be inserted through a hole in the base and be held in a vertical position by the ground and the base. One example of an open base is a base for an open umbrella. For example, the shaft of an open umbrella may be inserted into a patio table such that the shaft of the umbrella slides completely through the patio table such that an end of the umbrella shaft rests on the ground while being held in a vertical position by the patio table. Open bases do not necessarily support the weight of an object. Rather, open bases typically prevent objects intended to be held vertically from falling by allowing the weight of the object to rest on another surface, such as the ground, and applying only the force required to keep the object in a vertical position.

Another example of conventional bases includes tripods, bipods, and monopods. Each of these bases provides a number of legs that support an object connected, usually, to the top of the legs. For example, tripods are conventionally the most stable of these conventional bases, having three legs, which makes them ideal for use in photography, astronomy, surveying, and spotting. Typically, a camera, a telescope, or a spotting scope may be mounted on top of a tripod. A user may manipulate the legs to adjust the height and the stability of the tripod to capture a particular view through a camera, for example. Bipods are less stable than tripods in that bipods only include two legs, but allow for more simple operation. Bipods are preferable in some situations where a great deal of movement is required, such as when shooting a rifle. Bipods may be mounted to rifles to allow a shooter a wide range of motion while still providing adequate support to the rifle to assist the shooter in making an intended shot. A monopod includes a single leg and is typically not intended to be steady on its own. For example, a leg on a crutch or a cane may be considered a monopod, which is intended to work with another crutch, and one or more of the user's legs to provide support the user needs.

Many of these conventional bases, and others, are inadequately robust to support heavy loads. Further, conventional bases are less resistant to outside impacts than is often desirable. For example, target stand bases are typically wholly inadequate for use as a base to a target stand as they are easily destroyed by the impact of a bullet fired from a firearm. These conventional bases further lack the ability to collapse into smaller more portable forms. Likewise, these conventional bases do not provide rotational adjustment for the legs causing objects that are held vertically to be inadequately supported under some conditions.

It is, therefore, one object of this disclosure to provide a base, which is robust enough to support heavy loads. Another object of this disclosure is to provide a collapsible base that resists damage from object impacting the collapsible base. A further object of this disclosure is to provide a collapsible base that provides one or more pivotable supports to allow the collapsible base to collapse into a smaller more portable form. Finally, an object of this disclosure is to provide pivotable supports that allow rotational adjustment around a circumference of the base.

### SUMMARY

Disclosed herein is a support base. The support base includes a support leg that is rigidly joined to a first connector and a second connector. The first connector includes a post aperture while the second connector also includes a second post aperture. The first connector and the second connector further include a plurality of pinning apertures. The support base also includes a pivotable support leg, which includes a pin that is disposed within one of the plurality of pinning apertures in the first connector and within one of the plurality of pinning apertures in the second connector. In this manner, the support base may be collapsible by pivoting or rotating the pivotable support leg towards the support leg.

### BRIEF DESCRIPTION OF THE DRAWINGS

The accompanying drawings illustrate an embodiment of collapsible support base for vertical posts.

FIG. 1 illustrates a top perspective view of a collapsible support base for vertical posts.

FIG. 2 illustrates a bottom perspective view of a collapsible support base for vertical posts.

FIG. 3 illustrates a side view of a collapsible support base for vertical posts.

FIG. 4 illustrates a connector for a collapsible support base for vertical posts.

FIG. 5 illustrates support leg for a collapsible support base for vertical posts.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the rope end safety device disclosed herein. While the techniques and embodiments will primarily be described in context with the accompanying drawings, those skilled in the art will further appreciate the techniques and embodiments may also be practiced in other similar apparatuses.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

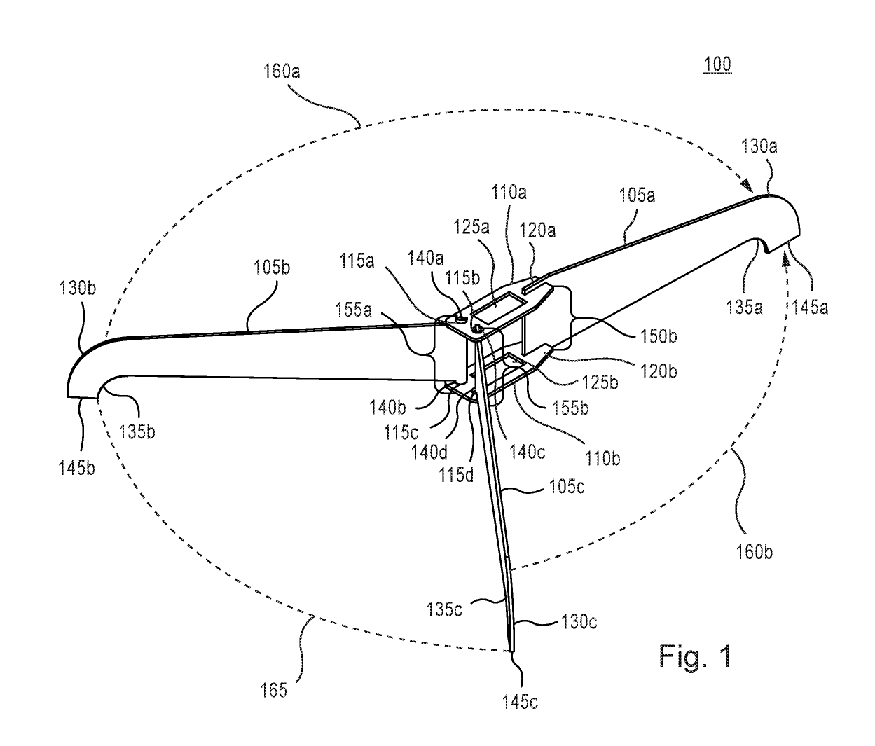

FIG. 1 illustrates a collapsible support base 100 for vertical posts. As used herein, the term “vertical posts” is to be interpreted broadly and may include any object rising from collapsible support base 100. The term “vertical” is not limited to objects, which rise from collapsible support base 100 at only a perpendicular angle to collapsible support base 100. Rather, the term “vertical” is intended to include objects, which may be inserted into collapsible support base 100 and which extend above a topmost surface of collapsible support base 100, in any direction.

Collapsible support base 100 includes support leg 105a, support leg 105b, and support leg 105c. Support leg 105a may be permanently attached to a top connector 110a and a bottom connector 110b using techniques known in the art. Typically collapsible support base 100 may be constructed using hardened steel, such as AR-500 steel or other metals with a Brinell hardness value of 500 or greater. However, it is conceived that other metals may be used such as titanium, aluminum, iron, and other metal alloys. Thus, in many circumstances, support leg 105a may be welded to top connector 110a and bottom connector 110b. Top connector 110a includes a first pinning aperture 115a and a second pinning aperture 115b. Bottom connector 110b also includes a first pinning aperture 115c and a second pinning aperture 115d. Pinning apertures 115a-115d will be discussed in more detail below.

In one embodiment, support leg 105a may be welded into a slot 120a disposed within top connector 110a and another symmetrical slot 120b disposed within bottom connector 110b. Slot 120a and slot 120b allow support leg 105 to be connected to slot 120a and slot 120b via, for example, joining techniques known in the art, such as welding. Thus, top connector 110a and bottom connector 110b are permanently rigidly joined to support leg 105a by welding support leg 105a into slot 120a and 120b, respectively such that support leg 105a does not pivot or rotate. Top connector 110a further includes a post aperture 125a while bottom connector 110b includes a post aperture 125b.

Post aperture 125a and post aperture 125b interface with a vertical post such that the post may be held in a vertical manner. In one embodiment, post aperture 125a and post aperture 125b may be symmetrical and square relative to each other creating an open type base. In one embodiment, post aperture 125a and post aperture 125b may be square shaped (e.g., may be equal in both length and width—4 inches by 4 inches), rectangular shaped (e.g., may be longer in length than width—2 inches by 4 inches), circular, wedge shaped, triangular, or any other shape to accommodate a particular implementation. For example, in one embodiment, post aperture 125a and post aperture 125b may be shaped and sized to accommodate a standard 2 inch by 4 inch piece of lumber (referred to commonly as a “2 by 4”). It should also be noted that a “standard” does not exist with respect to “2 by 4” lumber and many pieces of lumber are not actually two inches by four inches. Notwithstanding, post aperture 125a and post aperture 125b may be shaped and sized to accommodate both standard and non-standard pieces of “2 by 4” lumber. In another embodiment, post aperture 125a and post aperture 125b may be wedge shaped to accommodate a particular size of angle iron (e.g., 2″ angle iron, having two two-inch pieces of steel joined at a 90° angle relative to each other). In other implementations, post aperture 125a and post aperture 125b may be polygonal, pentagonal, hexagonal, heptagonal, octagonal, etc. to accommodate various post connectors. One advantage of polygonal shapes for implementation in post aperture 125a and post aperture 125b is that a post may be rotated at an angle, less than 90°. In some embodiments, where collapsible support base is acting as a base for a firearm target stand, slight rotations of a post, relative to a shooter, may be desirable to reduce the possibility of being struck by a ricochet or may be desirable to simulate a particular training scenario.

Support leg 105a extends from a connecting portion of support leg 105a outwardly from top connector 110a and bottom connector 110b at a length suitable for a particular implementation. For example, in some cases, it may be desirable that support leg 105a is longer or shorter to provide adequate support for a vertical post of a particular height. However, in each case, support leg 105a terminates with an outside radius 130a, which essentially turns a top surface of support leg 105a 90° towards an outside of foot 145a. Support leg 105a includes a corresponding inside radius 135a, which essentially turns a bottom surface of support leg 105a 90° towards an inside of foot 145a. Foot 145a may rest on top of a surface, such as the ground, or may dig into a surface. For example, collapsible support base 100 may be set up on a surface of earth and foot 145a may be driven into the earth to better support a vertical post.

Support leg 105b includes a pin top 140a and a pin bottom 140b, which are disposed in pinning aperture 115a and pinning aperture 115c, respectively, within top connector 110a and bottom connector 110b, which will be explained in more detail below. Support leg 105b extends outwardly from top connector 110a and bottom connector 110b at a length suitable for a particular implementation. The connection between support leg 105 and top connector 110a and bottom connector 110b will be further discussed below. In some cases, it may be desirable that support leg 105b is longer or shorter to provide adequate support for a vertical post. However, in each case, support leg 105b terminates with an outside radius 130b, which essentially turns a top surface of support leg 105b 90° towards an outside of foot 145b. Support leg 105b includes a corresponding inside radius 135b, which essentially turns a bottom surface of support leg 105b 90° towards an inside of foot 145b. Foot 145b may rest on top of a surface, such as the ground, or may dig into a surface. For example, collapsible support base 100 may be set up on a surface of earth and foot 145b may be driven into the earth to better support a vertical post.

Support leg 105c includes a pin top 140c and a pin bottom 140d, which are disposed in pinning aperture 115b and pinning aperture 115d, respectively, within top connector 110a and bottom connector 110b, which will be explained in more detail below. Support leg 105c also extends outwardly from top connector 110a and bottom connector 110b at a length suitable for a particular implementation. The connection between support leg 105c and top connector 110a and bottom connector 110b will be further discussed below. For example, in some cases, it may be desirable that support leg 105c is longer or shorter to provide adequate support for a vertical post. However, in each case, support leg 105c terminates with an outside radius 130c, which essentially turns a top surface of support leg 105c 90° towards an outside of foot 145c. Support leg 105c includes a corresponding inside radius 135c, which essentially turns a bottom surface of support leg 105c 90° towards an inside of foot 145c. Foot 145c may rest on top of a surface, such as the ground, or may dig into a surface. For example, collapsible support base 100 may be set up on a surface of earth and foot 145c may be driven into the earth to better support a vertical post.

Top connector 110a and bottom connector 110b may be spaced apart from each other at a first distance 150. For example, when support leg 105a is welded to top connector 110a via slot 120a, bottom connector 110b may be welded to support leg 105a at a first distance 150 away. First distance 150, may therefore be the distance along a connecting portion of support leg 105a between a top of top connector 110a and a bottom of bottom connector 110b. First distance 150 may be equal to or less than a length 155a of support leg 105b between a top of pin top 140a and a bottom of pin bottom 140b. Similarly, first distance 150 may be equal to or less than a length 155b of support leg 105c between a top of pin top 140c and a bottom of pin bottom 140d. In this manner, support leg 105b and support leg 105c are pinned in place by pin apertures 115a-d disposed within top connector 110a and bottom connector 110b.

Accordingly, collapsible support base 100 may be constructed by disposing pin top 140a of support leg 105b within pin aperture 115a of top connector 110a and pin bottom 140b of support leg 105b within pin aperture 115c of bottom connector 110b. Then, pin top 140b of support leg 105c may be disposed within pin aperture 115b of top connector 110a and pin bottom 140d of support leg 105c may be disposed within pin aperture 115d of bottom connector 110b. At this point, first distance 150 may be set by joining bottom connector 110b at slot 120b to support leg 105a and by joining top connector 110a at slot 120a to support leg 105a. When top connector 110a and bottom connector 110a are joined with support leg 105a, distance 150 being less than the length 155a of support leg 105b and length 155b of support leg 105c, support leg 105b and support leg 105c are pivotably trapped by pin apertures 115a-115d within top connector 110a and bottom connector 110b.

In this manner, support leg 105b may rotate along an axis 160a, which effectively allows support leg 105b to rotate to a position that is virtually parallel with support leg 105a. Similarly, support leg 105c may rotate along an axis 160b, which effectively allows support leg 105c to rotate to a position that is virtually parallel with support leg 105a. Thus, when support leg 105b and support leg 105c are rotated to a position that is virtually parallel to support leg 105a, collapsible support base 100 is collapsed into a much smaller and much more portable form. Further, support leg 105b and support leg 105c when in an operating position (i.e., an un-collapsed position), may be positioned anywhere along axis 160a and axis 165. Axis 165 is an axis defined as being the range of motion for support leg 105b towards support leg 105c and the range of motion for support leg 105c towards support leg 105b. In other words, the rotational movement of support leg 105b may be bounded approximately by support leg 105a and a point where support leg 105b is stopped by touching support leg 105c between top pin 115b and bottom pin 115d. Similarly, support leg 105c may be positioned anywhere along axis 160b and axis 165. In other words, the rotational movement of support leg 105c may be bounded approximately by support leg 105a and a point where support leg 105c is stopped by touching support leg 105b between top pin 115a and bottom pin 115c. In this manner, at least one of support legs 105b and 105c may be positioned virtually anywhere in a 360 degree arc. A desirable implementation, however, positions support leg 105b and support leg 105c at approximately 120° from each other and from support leg 105a.

It is also noted that collapsible support base 100 may include additional support legs. For example, top connector 110a and bottom connector 110b may be elongated to include several additional post apertures in addition to post aperture 125 and post aperture 125b, accommodating several posts in a side by side fashion. In some embodiments, when top connector 110a and bottom connector 110b are elongated, it may be desirable to add one or more additional support legs, which may be pinned into additional apertures disposed in both top connector 110a and bottom connector 110b to provide additional support for the elongated connectors using the techniques described herein.

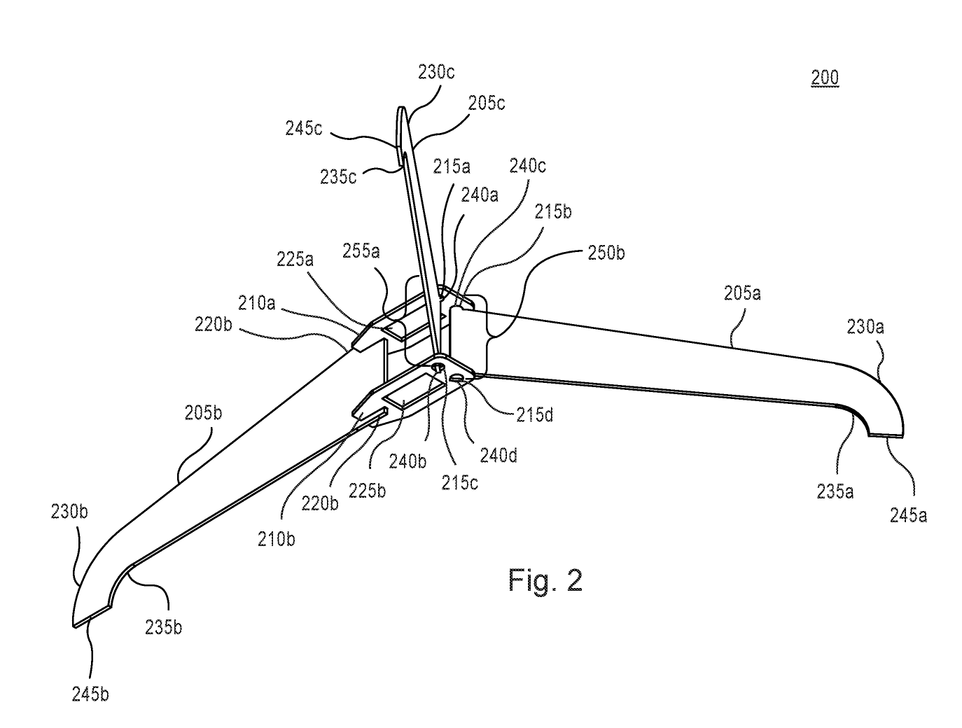

FIG. 2 illustrates bottom perspective view of a collapsible support base 200 for vertical posts. Collapsible support base 200 is similar in implementation and description to collapsible support base 100, shown in FIG. 1. Collapsible support base 200 includes support leg 205a, support leg 205b, and support leg 205c. Support leg 205a may be permanently attached to a top connector 210a and a bottom connector 210b using techniques known in the art. Typically collapsible support base 200 may be constructed using hardened steel, such as AR-500 steel or other metals with a Brinell hardness value of 500 or greater. However, it is conceived that other metals may be used such as titanium, aluminum, iron, and other metal alloys. Thus, in many circumstances, support leg 205a may be welded to top connector 210a and bottom connector 210b. Top connector 210a includes a first pinning aperture 215a and a second pinning aperture 215b. Bottom connector 210b also includes a first pinning aperture 215c and a second pinning aperture 215d. Pinning apertures 215a-215d will be discussed in more detail below.

In one embodiment, support leg 205a may be welded into a slot 220a disposed within top connector 210a and another symmetrical slot 220b disposed within bottom connector 210b. Slot 220a and slot 220b allow support leg 205 to be connected to slot 220a and slot 220b via, for example, joining techniques known in the art, such as welding. Thus, top connector 210a and bottom connector 210b are permanently joined to support leg 205a by welding support leg 205a into slot 220a and 220b, respectively. Top connector 210a further includes a post aperture 225a while bottom connector 210b includes a post aperture 225b.

Post aperture 225a and post aperture 225b interface with a vertical post such that the post may be held in a vertical manner. In one embodiment, post aperture 225a and post aperture 225b may be symmetrical and square relative to each other, creating an open type base. In one embodiment, post aperture 225a and post aperture 225b may be square shaped (e.g., may be equal in both length and width—4 inches by 4 inches), rectangular shaped (e.g., may be longer in length than width—2 inches by 4 inches), circular, wedge shaped, triangular, or any other shape to accommodate a particular implementation. For example, in one embodiment, post aperture 225a and post aperture 225b may be shaped and sized to accommodate a standard 2 inch by 4 inch piece of lumber (referred to commonly as a “2 by 4”). It should also be noted that a “standard” does not exist with respect to “2 by 4” lumber and many pieces of lumber are not actually two inches by four inches. Notwithstanding, post aperture 225a and post aperture 225b may be shaped and sized to accommodate both standard and non-standard pieces of “2 by 4” lumber. In another embodiment, post aperture 225a and post aperture 225b may be wedge shaped to accommodate a particular size of angle iron (e.g., 2″ angle iron, having two two-inch pieces of steel joined at a 90° angle relative to each other). In other implementations, post aperture 225a and post aperture 225b may be polygonal, pentagonal, hexagonal, heptagonal, octagonal, etc., to accommodate various post connectors. One advantage of polygonal shapes for implementation in post aperture 225a and post aperture 225b is that a post may be rotated at an angle, less than 90°. In some embodiments, where collapsible support base is acting as a base for a firearm target stand, slight rotations of a post, relative to a shooter, may be desirable to reduce the possibility of being struck by a ricochet or may be desirable to simulate a particular training scenario.

Support leg 205a extends from a connecting portion of support leg 205a outwardly from top connector 210a and bottom connector 210b at a length suitable for a particular implementation. For example, in some cases, it may be desirable that support leg 205a is longer or shorter to provide adequate support for a vertical post of a particular height. However, in each case, support leg 205a terminates with an outside radius 230a, which essentially turns a top surface of support leg 205a 90° towards an outside of foot 245a. Support leg 205a includes a corresponding inside radius 235a, which essentially turns a bottom surface of support leg 205a 90° towards an inside of foot 245a. Foot 245a may rest on top of a surface, such as the ground, or may dig into a surface. For example, collapsible support base 200 may be set up on a surface of earth and foot 245a may be driven into the earth to better support a vertical post.

Support leg 205b includes a pin top 240a and a pin bottom 240b, which are disposed in pinning aperture 215a and pinning aperture 215c, respectively, within top connector 210a and bottom connector 210b, which will be explained in more detail below. Support leg 205b extends outwardly from top connector 210a and bottom connector 210b at a length suitable for a particular implementation. The connection between support leg 205 and top connector 210a and bottom connector 210b will be further discussed below. In some cases, it may be desirable that support leg 205b is longer or shorter to provide adequate support for a vertical post. However, in each case, support leg 205b terminates with an outside radius 230b, which essentially turns a top surface of support leg 205b 90° towards an outside of foot 245b. Support leg 205b includes a corresponding inside radius 235b which essentially turns a bottom surface of support leg 205b 90° towards an inside of foot 245b. Foot 245b may rest on top of a surface, such as the ground, or may dig into a surface. For example, collapsible support base 200 may be set up on a surface of earth and foot 245b may be driven into the earth to better support a vertical post.

Support leg 205c includes a pin top 240c and a pin bottom 240d which are disposed in pinning aperture 215b and pinning aperture 215d, respectively, within top connector 210a and bottom connector 210b, which will be explained in more detail below. Support leg 205c also extends outwardly from top connector 210a and bottom connector 210b at a length suitable for a particular implementation. The connection between support leg 205c and top connector 210a and bottom connector 210b will be further discussed below. For example, in some cases, it may be desirable that support leg 205c is longer or shorter to provide adequate support for a vertical post. However, in each case, support leg 205c terminates with an outside radius 230c, which essentially turns a top surface of support leg 205c 90° towards an outside of foot 245c. Support leg 205c includes a corresponding inside radius 235c, which essentially turns a bottom surface of support leg 205c 90° towards an inside of foot 245c. Foot 245c may rest on top of a surface, such as the ground, or may dig into a surface. For example, collapsible support base 200 may be set up on a surface of earth and foot 245c may be driven into the earth to better support a vertical post.

Top connector 210a and bottom connector 210b may be spaced apart from each other at a first distance 250. For example, when support leg 205a is welded to top connector 210a via slot 220a, bottom connector 210b may be welded to support leg 205a at a first distance 250 away. First distance 250, may therefore be the distance along a connecting portion of support leg 205a between a top of top connector 210a and a bottom of bottom connector 210b. First distance 250 may be equal to or less than a length 255a of support leg 205b between a top of pin top 240a and a bottom of pin bottom 240b. Similarly, first distance 250 may be equal to or less than a length 255b of support leg 205c between a top of pin top 240c and a bottom of pin bottom 240d. In this manner, support leg 205b and support leg 205c are pinned in place by pin apertures 215a-d disposed within top connector 210a and bottom connector 210b.

Accordingly, collapsible support base 200 may be constructed by disposing pin top 240a of support leg 205b within pin aperture 215a of top connector 210a and pin bottom 240b of support leg 205b within pin aperture 215c of bottom connector 210b. Then, pin top 240b of support leg 205c may be disposed within pin aperture 215b of top connector 210a and pin bottom 240d of support leg 205c may be disposed within pin aperture 215d of bottom connector 210b. At this point, first distance 250 may be set by joining bottom connector 210b at slot 220b to support leg 205a and by joining top connector 210a at slot 220a to support leg 205a. When top connector 210a and bottom connector 210a are joined with support leg 205a, distance 250 being less than the length 255a of support leg 205b and length 255b of support leg 205c, support leg 205b and support leg 205c are pivotably trapped by pin apertures 215a-215d within top connector 210a and bottom connector 210b.

It is also noted that collapsible support base 200 may include additional support legs. For example, top connector 210a and bottom connector 210b may be elongated to include several additional post apertures in addition to post aperture 225 and post aperture 225b, accommodating several posts in a side by side fashion. In some embodiments, when top connector 210a and bottom connector 210b are elongated, it may be desirable to add one or more additional support legs, which may be pinned into additional apertures disposed in both top connector 210a and bottom connector 210b to provide additional support for the elongated connectors using the techniques described herein.

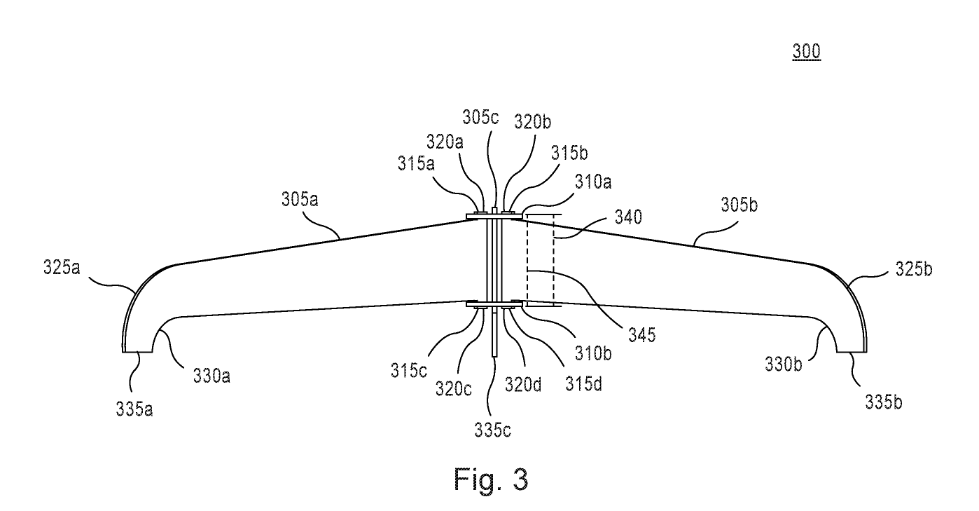

FIG. 3 illustrates a side view of collapsible support base 300 for vertical posts. Collapsible support base 300 may be similar in implementation and description to collapsible support base 100 shown in FIG. 1 and collapsible support base 200 shown in FIG. 2. As shown in FIG. 3, a support leg 305a, (which is analogous to support leg 105a shown in FIG. 1, for example) is provided in collapsible support base 300. Collapsible support base 300 further includes a support leg 305b, (which is analogous to support leg 105c shown in FIG. 1, for example.) Thus, the view of collapsible support base 300 shown in FIG. 3 is a side view looking into a pinning structure such that only a foot 335c of support leg 305c that is analogous to support leg 105a of FIG. 1 is visible.

Support leg 305a and support leg 305b are connected to top connector 310a and bottom connector 310b. Top connector 310a includes a pinning aperture 315a and a pinning aperture 315b. Bottom connector 310b includes a pinning aperture 315c and a pinning aperture 315b. Support leg 305a includes a top pin 320a and bottom pin 320c, which may be disposed within pinning aperture 315a of top connector 310a and pinning aperture 315c of bottom connector 310b. Similarly, support leg 305b includes a top pin 320b and bottom pin 320d, which may be disposed within pinning aperture 315b of top connector 310a and pinning aperture 315d of bottom connector 310b, as will be further discussed below.

Support leg 305a extends from top connector 310a and bottom connector 310b at a length suitable to support a particular vertical post. Support leg 305a terminates with an outside radius 325a, which essentially turns a top surface of support leg 305a 90° towards an outside of foot 335a and an inside radius 330a which essentially turns a bottom surface of support leg 305a 90° towards an inside of foot 335b. Similarly, support leg 305b extends from top connector 310a and bottom connector 310b at a length substantially equal to the length of support leg 305a and support leg 305c, which is suitable to support a particular vertical post. Support leg 305b terminates with an outside radius 325b, which essentially turns a top surface of support leg 305b towards an outside of foot 335b and an inside radius 330b, which essentially turns a bottom surface of support leg 305b 90° towards an inside of foot 335b. Foot 335a, foot 335b, and foot 335c may rest on top of a surface, such as the ground, or may dig into a surface. For example, collapsible support base 300 may be set up on a surface of earth and foot 335a, foot 335b, and foot 335c may be driven into the earth to better support a vertical post.

Top connector 310a and bottom connector 310b may be a set distance 150 apart from each other by joining top connector 310a and bottom connector 310b at distance 150 along a connecting portion of support leg 305c. Distance 150 may be defined as the distance between the top of top connector 310a and the bottom of bottom connector 310b. Top pin 320a of support leg 305a may be disposed in pinning aperture 315a of top connector 310a while bottom pin 320c of support leg 305a may be disposed in pinning aperture 315b of bottom connector 310b. Further, in one embodiment, a length 345 between the top of top pin 320a and the bottom pin 320c may be equal to or greater than distance 150. Similarly, top pin 320b of support leg 305b may be disposed in pinning aperture 315b of top connector 310a while bottom pin 320d of support leg 305a may be disposed in pinning aperture 315d of bottom connector 310b. In this manner, support leg 305a and support leg 305b may be pinned into or trapped within top connector 310a and bottom connector 310b. When top connector 310a and bottom connector 310b are permanently joined to support leg 305c at distance 150, support leg 305a and support leg 305b are effectively rotatably pinned within pinning apertures within top connector 310a and bottom connector 310b. Because length 340 between a top of top pin 320a and a bottom of bottom pin 320c (or a top of top pin 320a and a bottom of bottom pin 320d) is greater than or equal to distance 345 between top connector 310a and bottom connector 310b, support leg 305a (and support leg 305b) are permanently disposed within pinning aperture 315a (or pinning aperture 315b) and pinning aperture 315c (or pinning aperture 315d). Thus, support leg 305a and support leg 305b may rotate by the pinned connection between support leg 305a, support leg 305b, top connector 310a and bottom connector 310b.

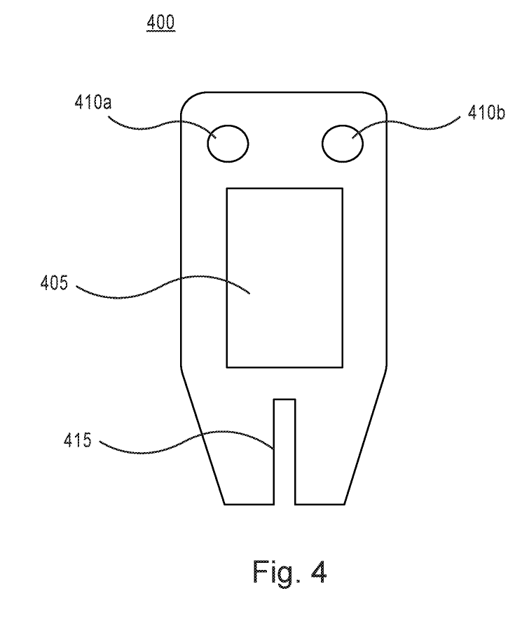

FIG. 4 illustrates a connector 400 for a collapsible support base for vertical posts, shown and discussed above with respect to FIGS. 1-3. Connector 400 may be implemented in a manner similar in implementation and description to top connector 110a and bottom connector 110b, top connector 210a and bottom connector 210b, and top connector 310a and bottom connector 310b shown and described above. Connector 400 includes a post aperture 405, which receives an object to be supported vertically by a collapsible support base. Connector 400 further includes a first pinning aperture 410a and a second pinning aperture 410b. First pinning aperture 410a and second pinning aperture 410b may receive a pin attached to a support leg and secure the pin within either first pinning aperture 410a or second pinning aperture 410b. Connector 400 may further include a slot 415 for receiving a connecting portion of a support leg. The connecting portion of a support leg may be permanently joined, by welding, for example, with connector 400 by inserting the connecting portion of the support leg into slot 415 and joining them.

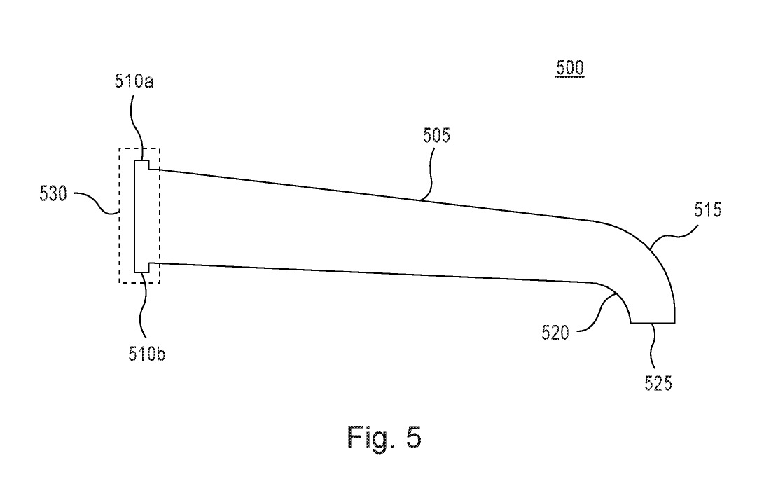

FIG. 5 illustrates support leg 500 for a collapsible support base for vertical posts. Support leg 500 includes an extension portion 505, which extends support leg 500 away from top pin 510a and bottom pin 510b at a distance sufficient to support an object attached to the collapsible support base in an upright or vertical position. Support leg 500 terminates with an outside radius 515, which essentially turns a top surface of support leg 505 90° towards an outside of foot 525. Support leg 500 includes a corresponding inside radius 520, which essentially turns a bottom surface of support leg 500 90° towards an inside of foot 525. Foot 525 may rest on top of a surface, such as the ground, or may dig into a surface. For example, the collapsible support base may be set up on a surface of earth and foot 525 may be driven into the earth to better support a vertical post.

Support leg 500 further includes a pin portion 530, which extends at a desired with, terminating at pin top 510a and pin bottom 510b. Pin portion 530 acts as a pin, which may be disposed in, for example, pin apertures in a connector, as shown and described above. In one embodiment, pin top 510a and pin bottom 510b may be rounded to facilitate rotating within a pin aperture. In another embodiment, pin top 510a and pin bottom 510b may be essentially flat. In this manner, support leg 500, including pin top 510a, pin bottom 510b, and pin portion 530 may simply be cut from a flat piece of hardened steel without substantially rounding pin top 510a and pin bottom 510b.

The foregoing description is presented for purposes of illustration. It is not exhaustive and does not limit the invention to the precise forms or embodiments disclosed. Modifications and adaptations are apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A support base, comprising:
a support leg rigidly joined to a first connector having a first post aperture and rigidly joined to a second connector having a second post aperture, wherein the first connector and the second connector include a plurality of pinning apertures; and
a pivotable support leg including a pin, which is disposed both within one of the plurality of pinning apertures in the first connector and one of the pinning apertures in the second connector.

2. The support base of claim 1, wherein the pin is longer than a distance between the first connector and the second connector.

3. The support base of claim 1, wherein the pin is as long as the distance between the first connector and the second connector.

4. The support base of claim 1, wherein the support leg is rigidly joined to first connector and the second connector within a slot disposed in the first connector and the second connector that receives the support leg.

5. The support base of claim 1, wherein the support leg, the first connector, the second connector, and the pivotable support leg are constructed from steel with a Brinell Hardness value exceeding 500.

6. The support base of claim 1, wherein the support leg extends from the first connector and the second connector and turns a top surface of the support leg 90° to an outside of a foot.

7. The support base of claim 6, wherein the support leg extends from the first connector and the second connector and turns a bottom surface of the support leg 90° to an inside of a foot.

8. The support base of claim 1, wherein the pivotable support leg extends from the first connector and the second connector and turns a top surface of the support leg 90° to an outside of a foot.

9. The support base of claim 8, wherein the pivotable support leg extends from the first connector and the second connector and turns a bottom surface of the support leg 90° to an inside of a foot.

10. The support base of claim 1, further comprising:
another pivotable support leg including a pin, which is disposed both within another one of the plurality of pinning apertures in the first connector and another one of the pinning apertures in the second connector.

11. The support base of claim 1, wherein the another pivotable support leg extends from the first connector and the second connector and turns a top surface of the support leg 90° to an outside of a foot.

12. The support base of claim 11, wherein the another pivotable support leg extends from the first connector and the second connector and turns a bottom surface of the support leg 90° to an inside of a foot.

13. The support base of claim 1, wherein the support base of claim 1 is collapsible.

14. The support base of claim 13, wherein the pivotable support leg rotates into physical contact with the support leg.

15. The support base of claim 1, wherein the post aperture is square.

16. The support base of claim 1, wherein the post aperture is rectangular.

17. The support base of claim 1, wherein the post aperture is circular.

18. A support base, comprising:
a support leg rigidly joined to a first connector and a second connector and
a pivotable support leg pinned into the first connector and the second connector.

19. The support base of claim 18, further comprising:
another pivotable support leg pinned into the first connector and the second connector.

20. The support base of claim 19, wherein the pivotable support leg and the another pivotable support leg are each pinned into one pin aperture in the first connector and one pin aperture in the second connector.
